(19) United States
(12) Patent Application Publication
(10) Pub. No.: US 2005/0178719 A1
(43) Pub. Date: Aug. 18, 2005

(54) Filter in the form of a roll and the method of making the same

(76) Inventor: Thomas E. Pank, Walkersville, MD (US)

Correspondence Address: William D. Hall, Esq., 10850 Stanmore Drive, Potomac, MD, 20854-1522, US

(21) Appl. No.: 11/030,939

(22) Filed: Jan. 7, 2005

Related U.S. Application Data
(60) Provisional application No. 60/543,942, filed on Feb. 12, 2004.

(51) Int. Cl. B01D 29/07

(52) U.S. Cl. 210/497.1

(57) ABSTRACT

A filter for filtering fluids is made by stacking two or more strips of flexible material and then wrapping the stack around a center line to form a spiral shaped roll that has several laps of said strips. The resulting roll has an input side which is the bottom wall of a reservoir which contains the fluid to be filtered such as the runoff water from a parking lot. The reservoir may have a by-pass outlet which by-passes the water around the filter in the event that the flow rate of the incoming runoff water exceeds the maximum rate of flow at which the filter is efficient. The strips guide the fluid as the fluid passes through the filter.

### RELATED CASE

I hereby claim the benefit of my prior copending Provisional Application Ser. No. 60/543,942, filed Feb. 12, 2004.

### BACKGROUND OF THE INVENTION

U.S. Pat. Nos. 5,746,911 and 6,264,835, both titled “Apparatus for separating a heavy fluid from a light fluid” teach physical separators that accomplish a great deal and are an important factor in environmental protection. However, they do not remove dissolved contaminants: nor do they remove sediment particles in the fine silt and clay size range.

Filtration is a proven method of removing dissolved and very fine impurities from a fluid. The most commonly used filter in the stormwater industry is a depth filter. A depth filter uses a media (sand, for example) that the fluid must pass through. The removal is achieved by a combination of two mechanisms: transport and attachment. In a sand filter, the individual grains obstruct the flow of the water, forcing the fluid to take a more tortuous path through the filter. When this happens, the fluid comes into contact with far more of the media than it would if it were to flow straight through the filter. The fluid, along with the impurities to be removed, is in contact with the individual grains of sand or other filter media. Bringing the contaminants into contact with the filter media is the first stage—the contaminants are transported into contact with the filter media.

In order to remove the pollutants from the fluid, the media must have some way of capturing and retaining the contaminant. This can be accomplished in a number of ways, first chemical bonding on reactive media to simple sedimentation in the interstices between the media components. When designed carefully, media filtration is capable of removing large pollutant loads from influent fluid streams.

The selection of filter media can depend on many factors, including the type of contaminants targeted for removal, the desired flow rates through the filter, the cost and weight of the media, etc. While filtration is a proven technology in fields like wastewater and drinking water treatment and industrial processes, it is relatively new in the field of stormwater treatment.

One of the challenges of stormwater management is dealing with the highly variable runoff flow rates that result from storms. In stormwater applications, treatment devices are subjected to widely varying flow rates, from very slow trickles to the runoff resulting from torrential downpours. To accommodate these variations, many stormwater treatment devices are designed with an internal by-pass. The internal by-pass allows flows in excess of the intended treatment capacity to pass through the unit untreated, while continuing to treat flows within the intended range. This is a viable technology because of the “first flush” effect in stormwater runoff. During the beginning of a storm event, a “flush” of contaminants is carried off of a site with the first bit of runoff. This flush includes the pollutants that have collected on that site since the last storm, and comprises the majority of the pollution load from each storm event. If the first flush is treated adequately, a majority of the potential contaminants will be removed during that treatment, and the subsequent by-pass flows during extreme storms will not contain the same heavy pollutant loads.

Filters that clean fluids, namely gasses and liquids are well known.

Filters for cleaning runoff water are well known but are not only expensive to manufacture but require expensive maintenance.

Filters made by rolling a strip of fabric into a spiral coil having several laps are well known, see U.S. Pat. No. 5,160,039 to Colburn and U.S. Pat. No. 4,861,465 to Augustyniak.

U.S. Pat. No. 6,099,729 to Cella teaches a filter having a hollow cylinder with a single lap of a pleated filtering element passing around the cylinder. The pleated element has several layers of flexible material.

### SUMMARY OF THE INVENTION

One object of the invention is to provide a filter that will clean both liquids and gasses.

Another object of the invention is to reduce the cost of the filter and its maintenance.

Still another object of the invention is to provide a simple, yet very effective, filter for runoff water that has a low initial cost as well as low maintenance costs.

The invention not only provides a new filter but also a new method of making the filter.

Basically, the invention comprises providing two or more strips of flexible material (including a filtering media), stacking the strips and wrapping the contiguous strips around a center line to provide a filtering element wherein at least part of the wrapped strips overlaps the first lap. In its broadest form the amount of overlap may be small, for example 10°, however two laps (720°), three laps (1080°), or preferably about ten to fifteen laps may be employed.

The fluid (liquid and/or gasses) to be filtered is preferably fed to the filter in a direction parallel to said center line although it is within the scope of the broader aspects of the invention to pass the fluid through the roll in any suitable way and/or direction.

In the preferred form of the invention there are three strips which are stacked and wrapped into a roll. When the strips have been wrapped and the fluid is fed to them it enters the first of the three strips. The second of the three strips is a filtering media and the third strip is a drain for discharging the fluid from the filter. The first strip not only receives the incoming fluid but redirects the fluid to pass the fluid through said filtering media to said drain.

To achieve the aforesaid redirecting function the first strip is open to receive fluid at its input end but closed to such flow at its other end. As a result, the water is redirected from a vertical incoming flow to a flow that has a horizontal component.

The drain is closed to the fluid at the input side of the filter but open at the output side of the filter.

The foregoing wrapped filter may be fed by a reservoir the bottom of which is the input side of the filter. The reservoir may have a by-pass outlet to discharge the water when the incoming water has a very large rate of flow.

While, the invention is shown in the context of a filter for runoff water, the broader aspects of the invention teach how to make and use the filter in any context in which filters may be used.

### BRIEF DESCRIPTION OF THE DRAWINGS

FIG. 1 is a plan view of the unrolled layered filter.

FIG. 2 is an elevation view of the unrolled layer filter, taken along line 2-2 as indicated in FIG. 1.

FIG. 3 is a plan view of the rolled filter cartridge.

FIG. 4 is a cross section of the assembled filter taken along line 4-4 in FIG. 3.

FIG. 5 is a cross section of the layered filter, in its pre-wrapped stage.

FIG. 6 is a plan view of the invention.

FIG. 7 is a cross section of the preferred form of the invention taken along line 7-7 in FIG. 6.

FIG. 8 is a cross section of a modified form of the invention.

FIG. 9 is a plan view of the unrolled layered filter of FIG. 8.

FIG. 10 is a cross section of a single lap of the layered filter of FIG. 8.

### DETAILED DESCRIPTION OF THE PREFERRED FORM OF THE INVENTION

The complete invention comprises a filter cartridge that is placed in a housing. Contaminated fluid enters the housing and pools on the top of the filter cartridge. The fluid may be contaminated with solid particles, undesirable gases, dissolved chemicals, or other pollutants. From the top of the filter cartridge, the contaminated fluid enters the cartridge by flowing downward, flows horizontally through the filter media, and then flows downward out of the cartridge itself. The filter housing contains the inlet and outlet means that convey the contaminated fluid to and the treated fluid away from the invention.

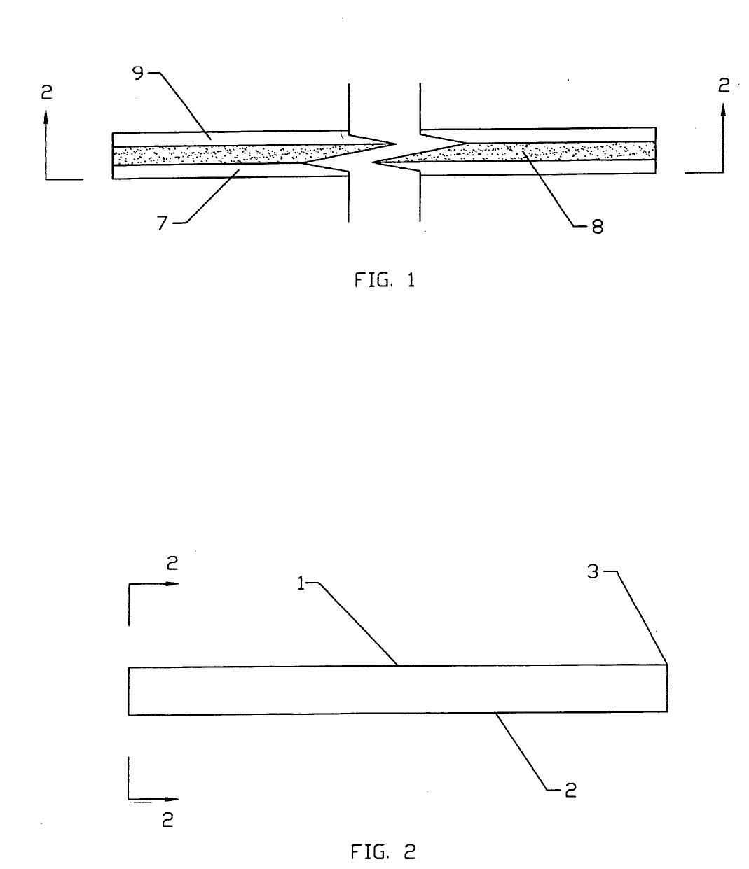

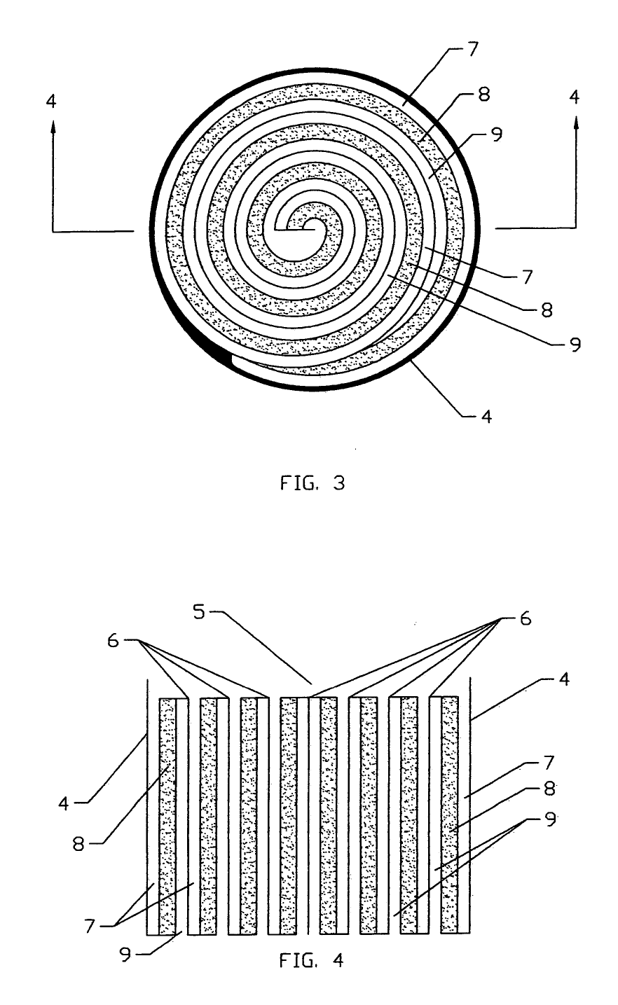

The method of constructing the invention is also a part of this application. The filter cartridge is constructed by rolling a layered filter around a center line. FIG. 1 shows a plan view and FIG. 2 shows an elevation view of the unrolled layered filter, with the top 1 and bottom 2 indicated. The layered filter is significantly longer than it is wide, and is flexible enough to be rolled around itself. The filter is constructed by taking a free end 3 of the unrolled filter and wrapping that end around the center line 2-2 indicated in FIG. 1. The unrolled filter must be long enough for the free end 3 to make more than one lap around the center line, and may be longer (up to many laps) to provide additional filtration capacity. The resulting cartridge is then oriented so that the top 1 and bottom 2 are in the correct positions. A plan view of the partially constructed filter cartridge is shown in FIG. 3. Outer walls 4 are affixed to the rolled filter cartridge to provide storage chamber 5. The seams 6 between the rolled layers may also be scaled to prevent the fluid from flowing between the layers instead of through the filter media.

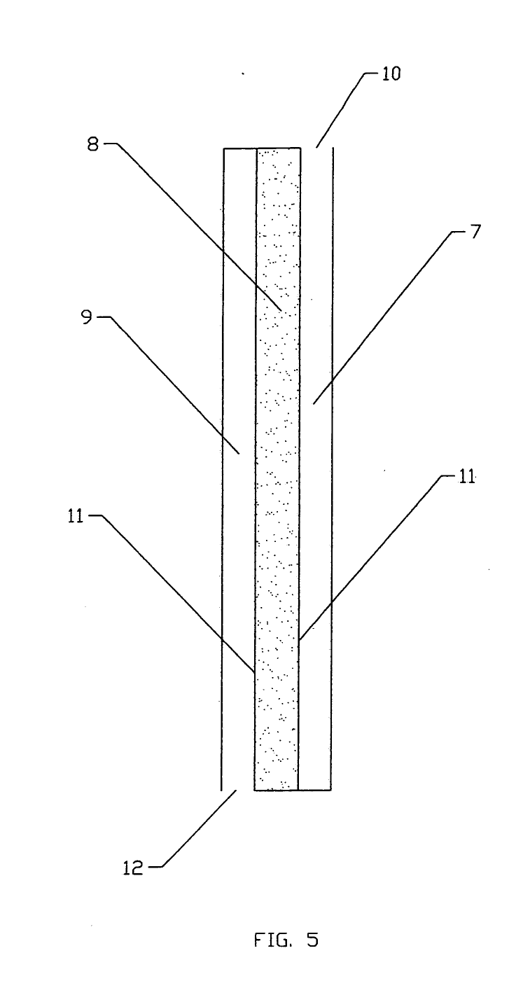

FIG. 4 shows a cross section of the completed filter cartridge, taken along line 2-2 as indicated in FIG. 2. During operation, each “lap” around the center line functions in the same way. FIG. 5 is a cross section of the layers before they are wrapped. The cross section is thin relative to its length and width so that it can be rolled. It is shown in FIG. 5 vertically oriented, in the same orientation it has in the complete invention. Each “lap” consists of three layers: an inlet layer 7, the filter media 8, and an outlet layer 9. The inlet layer is open at its upper end and allows water to enter the filter through openings 10. The center layer contains the filter media 8. The third layer, the outlet layer 9, has openings 12 at the bottom to allow the treated fluid to flow out of the filter unit.

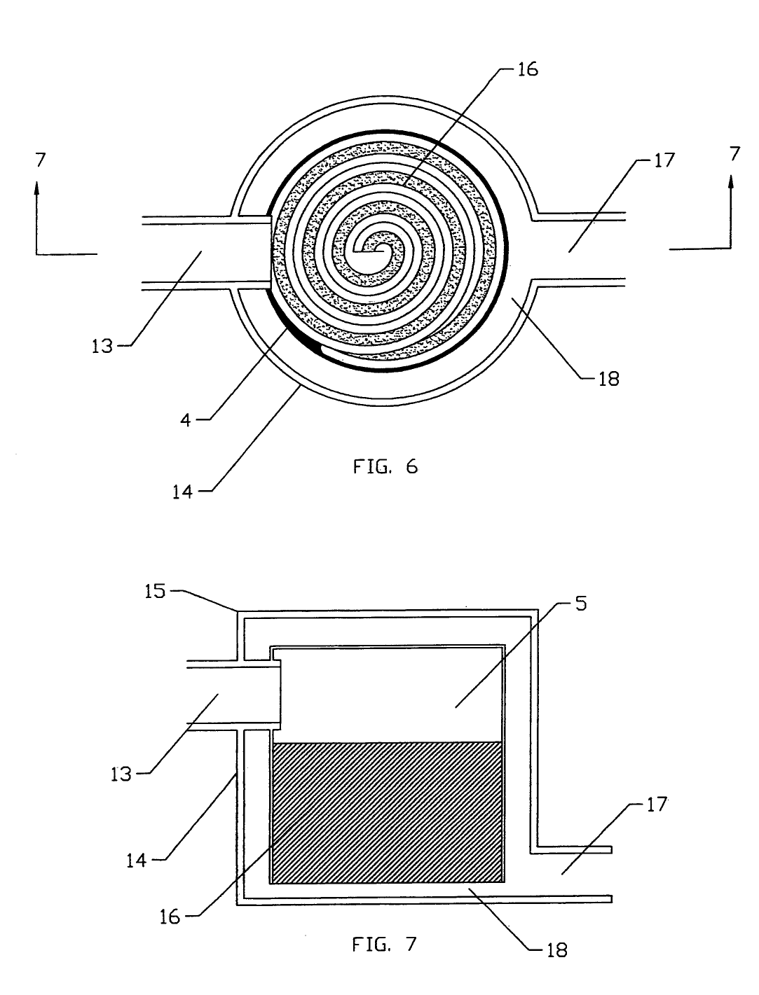

The completed filter cartridge is housed in another structure, as shown in FIG. 6. FIG. 6 is a plan view of the entire invention. Inlet means 13 penetrates through the wall 14 of the main structure 15 and through the outer wall 4 of the complete filter cartridge 16. Inlet means 13 has a discharge point that allows the influent fluid flow onto the top of the filter cartridge 16. The inlet means 13 is in communication with contaminated fluid storage chamber 5, which is in communication with cartridge inlet layer 7 through opening 10. In the preferred form of the invention, the contaminated fluid storage chamber 5 has a single influent flowpath (through inlet means 13) and a single outlet pathway (cartridge inlet layer 7 through opening 10). Outlet means 17 penetrates the outer wall of the main structure 15. The outlet means is in communication with the outlet chamber 18 of the main structure, which is in communication with the outlet layer 9 of the filter cartridge through openings 12.

In a typical filter for filtering runoff water: (a) the strips 7 and 9 are made of polypropylene cloth have a thickness of 0.3 inches and a width of 30 inches; and (b) the filter strip 8 is made of high grade geotextile fabric, has a thickness of 0.3 inches and a width of 30 inches.

Each input cloth 9 has one side edge that will be at the bottom end of the filter of FIG. 4. Each such edge is sealed with silicon. The upper side edge will be open and free to receive water from space 5 of FIG. 7. Each drain layer 7 has a first side edge, that will be at the top end of the filter and sealed closed with silicon so that water may not flow through that edge. The lower side edge of each drain layer is open so that the water in drain layer 7 may flow out of the bottom end of the filter. After the elements 7, 8, and 9 have been assembled as shown in FIG. 5, they form a flexible strip about one to two inches thick and many feet long. The resulting strip is now wrapped around a central post, or center line, so as to form a spiral.

For some applications the filter media 8 may preferably be sand or some other layer of small particles, in which case permeable layers 11 may be used. The permeable layers 11 are optional and are preferably used when it is necessary to do so in order to hold the filter media in place. They may be made of porous cloth.

### Operation of the Preferred Form of the Invention

Contaminated fluid enters the filter through inlet means 13. (FIG. 7). The fluid flows from inlet means 13 and into contaminated fluid storage chamber 5. Contaminated fluid storage chamber 5 is in communication with the cartridge inlet layer 7 in each lap of the rolled filter cartridge. The contaminated fluid flows from the contaminated fluid storage chamber 5 into cartridge inlet layer 7 through openings 10. In the cartridge inlet layer 7, the fluid makes a 90 degree turn and flows through the filter media 8. The fluid flows through the filter media 8, where the contaminants are removed by the media, and into the fluid outlet layer 9. In the fluid outlet layer 9, the fluid once again makes a 90 degree turn and flows downward, out of the filter cartridge through openings 12 and into the outlet chamber 18 of the main structure 15. The treated fluid then flows to the outlet means 17 and exits the invention through said outlet means.

If the flow into the invention through inlet means 13 exceeds the flow capacity of the filter media, the fluid is backed up in contaminated fluid storage chamber 5. When the head in this chamber rises, whether that rise is due to rising fluid surface elevation or rising pressure, the fluid within the filter cartridge 16 is driven through the filter media more quickly. The increased flow rate serves to relieve the rising head upstream from the invention.

### Detailed Description of a Modified Form of the Invention

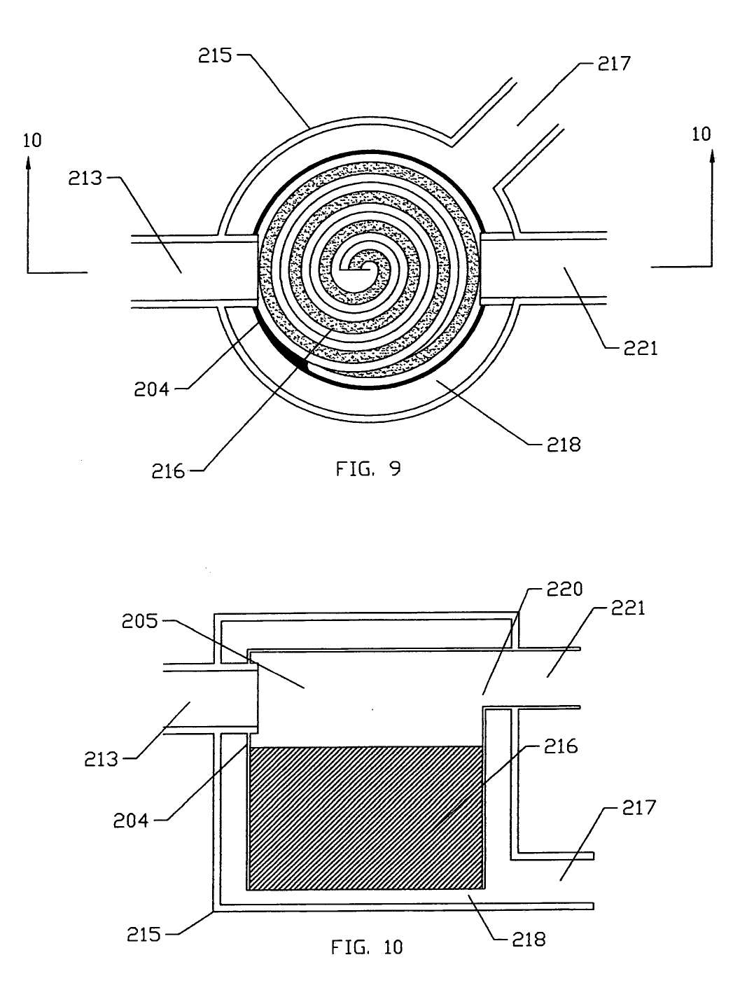

The modified form of the invention comprises an alternate layering of the rolled filter. The filter cartridge is again constructed by rolling a layered filter around a center line. FIG. 9 shows a plan view and FIG. 10 shows an elevation view of the unrolled layered filter, with the top 101 and bottom 102 indicated. The layered filter is significantly longer than it is wide, and is flexible enough to be rolled around itself. The filter is constructed by taking a free end 103 of the unrolled filter and wrapping that end around the line 11-11 indicated in FIG. 10. The unrolled filter must be long enough for the free end 103 to make at least more than one lap around the center line, and may be longer to provide additional filtration capacity. The resulting cartridge is then oriented so that the top 101 and bottom 102 are in the correct positions.

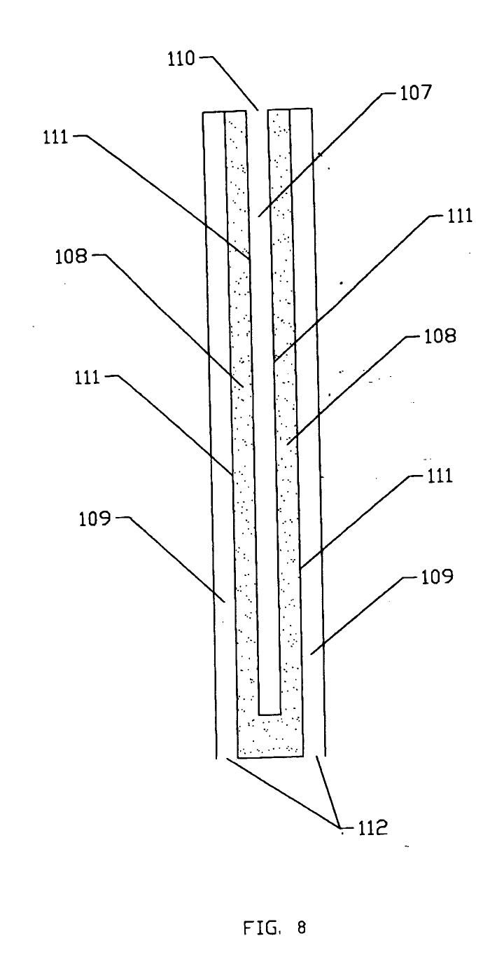

FIG. 8 shows a cross section of the unrolled layered filter, taken along line 11-11 as indicated in FIG. 10. The cross section is thin relative to its length and height so that it can be rolled. It is shown in FIG. 8 vertically oriented, with the same orientation it has in the complete invention. Each “lap” consists of three components: a center inlet layer 107, the U-shaped filter media layer 108, and the outlet drains 109. The center inlet layer is open at the top, and allows water to enter the filter through openings 110. The U-shaped media layer contains the filter media 108, and surrounds the inlet layer 107. Filter media 108 can be selected specifically for the anticipated pollutants to be removed from the influent fluid, and can be sand, fabric, or other material. If filter media 108 is of indeterminate shape (sand, for example), it is held in place by permeable barrier 111, through which the water can flow at a faster rate than it can flow through the filter media. The third component, the outlet drains 109, are separated from the filter media by permeable barrier 111 (when present). Outlet drains 109 have openings 112 at the bottom to allow the treated fluid to flow out of the filter unit.

In the modified form of the invention, the completed filter unit is placed in the invention housing in the same manner as it is in the preferred form.

### Operation of the Modified Form of the Invention

The operation of the first modified form of the invention is very similar to that of the preferred form. FIG. 6 and FIG. 7 show the layout of the first modified form of the invention as well as the preferred form. Contaminated fluid enters the invention through inlet means 213. The fluid flows from inlet means 213 and into contaminated fluid storage chamber 205. From contaminated fluid storage chamber 205, the influent fluid enters the filter cartridge 216.

The contaminated fluid flows from the contaminated fluid storage chamber 205 into cartridge inlet layer 107 through openings 110. In the cartridge inlet layer 107, the fluid makes a 90 degree turn in either direction and flows through permeable barrier 111 (when present) and into the filter media 108. The fluid flows through the filter media 108, where the contaminants are removed by the media, passes through permeable barrier 111 when present, and into one of two of the fluid outlet drains 109. In the fluid outlet drain 109, the fluid once again makes a 90 degree turn and flows downward, out of the filter cartridge through openings 112.

The treated fluid flow from the filter cartridge 216 into the outlet chamber 218 of the main structure 215. The treated fluid then flows to the outlet means 217 and exits the invention through said outlet means.

1. The method of making a filter for filtering a fluid comprising:
providing at least two adjacent layers of flexible materials at least one of which includes a filtering media, and
forming said layers into a filter element by passing said layers around a center line for 360 degrees to form a lap and further passing said layers at least part way around the filter element so that they overlap the said lap.

2. The method of making a filter for filtering a fluid as defined in claim 1, which includes passing a fluid, into at least one of said layers in a direction generally parallel to said center line.

3. The method of making a filter for filtering a fluid as defined in claim 1, comprising rotating said free end around said center line at least 720 degrees to provide at least three laps of said layers around said center line.

4. The method of making a filter for filtering a fluid as defined in claim 1 which includes:
wrapping said layers around said center line by at least 1080 degrees,
providing at least one of said layers with a configuration that will change the direction of any fluid flow entering said one layer,
said step of providing at least two adjacent layers comprising providing at least two contiguous layers.

5. The method of making a filter for filtering a fluid as defined in claim 4, wherein said step of providing at least two layers of materials comprises providing said filtering media as one of said layers and positioning said media in the path of fluid leaving said one layer.

6. The method of making a filter for filtering a fluid as defined in claim 5, comprising providing a drain for receiving fluid from said media, said drain also discharging said fluid from said filter.

7. A method of making a filter for filtering a fluid, comprising:
providing at least two flexible layers at least one of which includes a filtering media, each layer having a face,
wrapping said layers around a center line to form a roll,
said wrapping step placing the face of one of said layers contiguous with the face of the other layer, said wrapping step positioning said layers to have one complete 360° lap around a center line and also positioning an additional portion of said layers to at least partially overlap said 360 degrees lap.

8. A filter for filtering a fluid, comprising:
at least two adjacent layers of material with at least one of said layers including a filtering media,
said adjacent layers forming a wound filter element in which the first lap of the wound filter element extends around a center line for 360 degrees and in which said adjacent layers overlap said first lap.

9. A filter for filtering a fluid as defined in claim 8, in which said overlap extends around said center line by at least 360°.

10. A filter for filtering a fluid as defined in claim 8, in which one of said layers receives the fluid to be filtered and the other layer is a filtering media for said fluid, said one layer feeding at least some of the fluid it receives to said other layer.

11. A filter for filtering a fluid as defined in claim 10, in which said one layer changes the direction of the incoming fluid and feeds said fluid through said filtering media.

12. A filter for filtering a fluid as defined in claim 11, having a drain for receiving fluid that has passed through said filtering media, said drain discharging the fluid it receives.

13. A filter for filtering a fluid as defined in claim 8 in which:
at least one of said layers having an input,
a reservoir feeding liquid fluid to said input of said one layer.

14. A filter for filtering a fluid as defined in claim 8, in which said filter has plural inputs, and a reservoir feeds liquid fluid to said inputs.

15. A filter for filtering fluids as defined in claim 14, in which said reservoir is located above said layers, said layers forming the bottom of said reservoir.

16. A filter for filtering a fluid comprising:
at least two adjacent members that are in the form of a roll with said members having a spiral shape,
said spiral having a first lap of 360 degrees and additionally a second lap that at least to some degree overlaps said first lap.

17. A filter for filtering a fluid as defined in claim 16, in which said second lap extends around the roll for 360 degrees and said members also forming one or more additional laps.

18. A filter for filtering a fluid comprising:
at least three contiguous layers of material in the shape of a spiral and forming a roll, said roll having at least two laps of said layers,
the first of said layers receiving the fluid to be filtered,
the second of said layers comprising filtering media,
the third of said layers comprising a drain for discharging the filtered fluid from the filter,
said first layer directing the incoming fluid through said second layer to said drain.

19. A filter for filtering a fluid as defined in claim 18, in which each said layer has two side edges,
one of which side edges of each layer being an input side edge,
the other side edge of each layer being an output side edge,
said input side edges forming an input side of the filter and said output side edges of each layer forming an output side of the filter.

20. A filter for filtering a fluid as defined in claim 18, in which said input side is horizontal,
said fluid being a liquid.

21. A filter for filtering a fluid as defined in claim 18, in which said roll is cylindrical and has an input side,
said input side being the input for a fluid to enter the filter,
a reservoir,
said input side being the bottom of said reservoir.

22. A filter for filtering a fluid as defined in claim 21, in which said reservoir has a by-pass for allowing a liquid fluid to by-pass the filter when the reservoir input is a liquid fluid having a high rate of flow.

23. A filter for filtering a fluid as defined in claim 22, wherein said by-pass comprises: said reservoir is an enclosure having an inlet for feeding fluid to be filtered into said enclosure and having an outlet spaced above the filter so that when there is a high rate of flow into said enclosure unfiltered fluid is discharged from said outlet.

24. A filter for filtering a fluid as defined in claim 18, wherein there is a permeable barrier between said second and third layers.

25. The method of making a filter for filtering a fluid, comprising:
providing at least two layers of material and providing at least one of said layers with a filtering media,
forming a roll with said layers,
said forming step including positioning said layers into a contiguous relationship with each other, said forming step including wrapping said layers to provide a first lap of the roll that extends around a center line for 360 degrees and to also position said layers to overlap said first lap.
